(19) United States
(12) Patent Application Publication
(10) Pub. No.: US 2004/0201277 A1
(43) Pub. Date: Oct. 14, 2004

(54) Motor vehicle door locking system

(75) Inventors: Ingmar Hentsch, Wuppertal (DE); Frank Hegerfeld, Gelsenkirchen (DE)

Correspondence Address: NIXON PEABODY, LLP, 401 9TH STREET, NW, SUITE 900, WASHINGTON, DC, 20004-2128, US

(73) Assignee: Brose Schliesssysteme GmbH and Co. KG, Wuppertal (DE)

(21) Appl. No.: 10/815,846

(22) Filed: Apr. 2, 2004

(30) Foreign Application Priority Data
Apr. 8, 2003 (DE) 103 16 306.9
Apr. 8, 2003 (DE) 103 16 307.7

(51) Int. Cl. H02G 3/00

(52) U.S. Cl. 307/10.1

(57) ABSTRACT

Motor vehicle door locking system with at least one motor vehicle lock, the motor vehicle lock being made to be locked and unlocked by motor and optionally also opened by a motor, with a motor vehicle-side control and with an operator-side mobile part, the control and the mobile part each being equipped with communications electronics and thus a bidirectional wireless link can be set up between the control and the mobile part, over the wireless link, at least one system function of the motor vehicle door locking system being triggerable by the mobile part, and the wireless link between the control and the mobile part being a wireless link according to the Bluetooth industrial standard.

### BACKGROUND OF THE INVENTION

1. Field of the Invention

The present invention relates to a motor vehicle door locking system with a wireless link according to the Bluetooth industry standard.

2. Description of Related Art

Modern motor vehicle door locking systems increasingly offer the possibility of triggering the system functions remotely. Typical system functions in this connection are, for example, actuation of a central locking means or motorized opening of a rear hatch. To trigger these system functions, the operator carries the mobile part.

Electromechanical motor vehicle door locking systems with a mobile part, made as a wireless remote control, are known. By actuating a pushbutton on the wireless remote control a vehicle-side control can be activated which implements the desired system function after an authentication check interval.

Another known motor vehicle door locking system with a so-called “passive entry function”, also called an “electronic key”, differs from the above explained motor vehicle door locking system in that on the mobile part actuation need not be accomplished, therefore a button need not be pressed, in order to trigger the system function “actuation of the central locking means” when approaching the motor vehicle. Rather, this takes place automatically when the operator approaches the vehicle. The mobile part here is made as a data medium in which the respective access functions are stored. When the operator approaches the motor vehicle, the control is first activated in a starting interval in order to then read out the access data stored in the data medium in an authentication check interval and to check the authorization of the operator. Finally, the action interval in which the central locking means is actuated follows.

There are a series of possibilities for establishing communication between the motor vehicle-side control and the mobile part. In the motor vehicle door locking system described in DE 100 07 500 A1 underlying this invention, there is a bidirectional wireless link between the motor vehicle-side control and the mobile part which is made as a data medium. In this motor vehicle door locking system, the starting interval is started when the hand of the operator approaches the outside door handle of the motor vehicle. For this purpose, there is proximity sensing which, in one embodiment, is based on a radar principle (i.e., reflected waves can be detected by means of an antenna) and the corresponding evaluation electronics. The motor vehicle door locking system is therefore, to a certain extent, prompted by a proximity sensing signal (i.e., trigger signal).

One possible implementation of the aforementioned bidirectional wireless link resides in that both the motor vehicle-side control and the operator-side data medium each have a UHF transmitter and a UHF receiver. But, it is also known that the wireless link from the vehicle-side control to the operator-side data medium is made as a LF wireless link, which is then designed for a transmission length of less than 2 m. The reason for this short transmission length is that with it, unauthorized access to the motor vehicle from a long distance, (i.e., from an unauthorized individual at a safe distance) is to be avoided.

In the above-described motor vehicle door locking system, a mobile part has special communications electronics for communication between the mobile part and the motor vehicle-side control. In order to be able to transmit the respective access data to the control, the mobile part has its own power supply. In particular, when the mobile part is integrated into a key ring, a motor vehicle key or into a card, this leads to special problems in development due to the constricted space conditions.

One possibility of “sparing” the power supply of the mobile part and, thus, ensuring long standby times is offered by the above described triggering which, in any case, entails additional cost due to the requirement of proximity sensing. Therefore, in addition to proximity sensing both on the motor vehicle-side and the operator-side, one sensor and one receiver, each with the corresponding antennas, are necessary.

### SUMMARY OF THE INVENTION

A primary object of the present invention is to embody and develop the known motor vehicle door locking system such that the implementation of a wireless link is better matched to the given boundary conditions.

The aforementioned object is achieved in a motor vehicle door locking system with at least one motor vehicle lock in which the motor vehicle lock is made to be locked and unlocked by a motor and optionally opened by a motor, with a motor vehicle-side control and with an operator-side mobile part, the control and the mobile part each being equipped with communications electronics and thus a bidirectional wireless link can be set up between the control and the mobile part, over the wireless link at least one system function of the motor vehicle door locking system being triggerable by the mobile part and the wireless link between the control and the mobile part being a wireless link according to the Bluetooth industrial standard—a Bluetooth wireless link.

It is important that the wireless link between the motor vehicle-side control and the operator-side mobile part is a wireless link according to the Bluetooth industrial standard. The Bluetooth industrial standard offers a specification for communication between Bluetooth-capable devices which have a distance of a maximum 10 m relative to one another. The original objective of this industry standard was to replace cable connections for data transmission between individual devices with Bluetooth wireless links.

The attainable data transmission rate for a Bluetooth wireless link is 1 Mbit/s at a transmitted power of 1 mW in the license-free 2.4 GHz band (ISM band). One important advantage of the low transmitted power is the resulting low power consumption of the Bluetooth devices.

The Bluetooth industry standard offers high protection against unauthorized access to a Bluetooth device. This is provided by the complex communications protocol when the connection is set up, the encryption of data during transmission, and transmission in a special frequency changing process. Furthermore, it is fundamentally possible for the Bluetooth devices to “negotiate” the transmitted power among one another so that communication in the “whisper mode” is possible, so that eavesdropping from a long distance becomes difficult.

Finally, the Bluetooth industry standard is becoming increasingly popular in portable electronic devices, such as mobile telephones or PDAs, so that, both with respect to hardware and also software, a mass-produced article with the corresponding advantages with regard to price and availability is involved.

There are several possibilities regarding how Bluetooth devices can set up a connection to one another. One possibility is that one Bluetooth device works in a so-called “sniff mode.” In this mode, the Bluetooth device at periodic intervals, eavesdrops on the Bluetooth transmission frequencies and answers another device when it transmits a so-called “inquiry message” on one of the Bluetooth transmission frequencies. Thus, it is possible for two Bluetooth devices to automatically “discover” one another as soon as the two Bluetooth devices have approached to within 10 m of one another.

The properties of the Bluetooth industry standard, described in general above, lead to the fact that the configuration of the wireless link between the motor vehicle-side control and the operator-side mobile part is associated with special advantages.

First of all, it is advantageous that the Bluetooth wireless link is limited to 10 m. This constitutes the conventional radius within which triggering of system functions of a motor vehicle door locking system should be possible in any case.

The low power consumption is especially advantageous. The configuration of the mobile part is kept as small as possible. The use of batteries or battery systems leads to problems, for example, when the mobile part is integrated into a motor vehicle key.

Furthermore, it is advantageous that the Bluetooth industry standard already provides the described security mechanisms which are of special importance for access to a motor vehicle.

The fact that Bluetooth is an industry standard which is becoming increasingly widespread in mobile electronic devices yields the advantage that conventional mobile phones or PDAs can easily assume the function of the operator-side mobile part.

One special simplification for implementation of the motor vehicle door locking system entails the use of the Bluetooth industry standard for a motor vehicle door locking system with a passive entry function. The above described “sniff mode” or a similar service of the Bluetooth industry standard can be used to detect the approach of the operator to the motor vehicle and to set up the Bluetooth connection (starting interval).

In another preferred embodiment, the transmitted power is just enough to maintain the wireless link between the mobile part and the motor vehicle-side control. Thus, the transmission of security-relevant data is limited to the minimum necessary distance so that the danger of eavesdropping is reduced (whisper mode).

Within the framework of this invention, an unwanted unlocking process from an undesirably great distance is avoided since the distance between the motor vehicle and the mobile part to enable the unlocking process is determined by the control. Only starting with less than a certain distance does the control enable the unlocking process (EP 1 143 089 A2). To determine the distance, the control measures evaluate the motor vehicle-side reception level of the wireless link. Based on the use of a Bluetooth wireless link, this technology can now be embodied by at least two distance ranges being stipulated by the control within the area which surrounds the motor vehicle and which can be reached by an operator. The distance ranges can also partially overlap. Different system functions are assigned to the different distance ranges. The control enables the triggering of the system function when the mobile part is located within the distance range assigned to the pertinent system function.

Therefore, when an operator enters a certain distance range only the system function assigned to the distance range can be triggered. Thus, for example, the triggering of the luxury function (e.g., activation of the front end lights) can be allowed from a distance of 10 m, but the triggering of the unlocking process can be allowed only beginning at a distance of 3 m from the vehicle.

The invention is explained in detail below with reference to the accompanying drawings which show one preferred embodiment.

### BRIEF DESCRIPTION OF THE DRAWINGS

FIG. 1 shows a motor vehicle with the motor vehicle door locking system in a schematic perspective,

FIG. 2 shows in a block diagram the structure of a motor vehicle door locking system with a Bluetooth wireless link,

FIG. 3 shows the motor vehicle from FIG. 1 with three distance ranges being shown by the dot-dash lines.

### DETAILED DESCRIPTION OF THE INVENTION

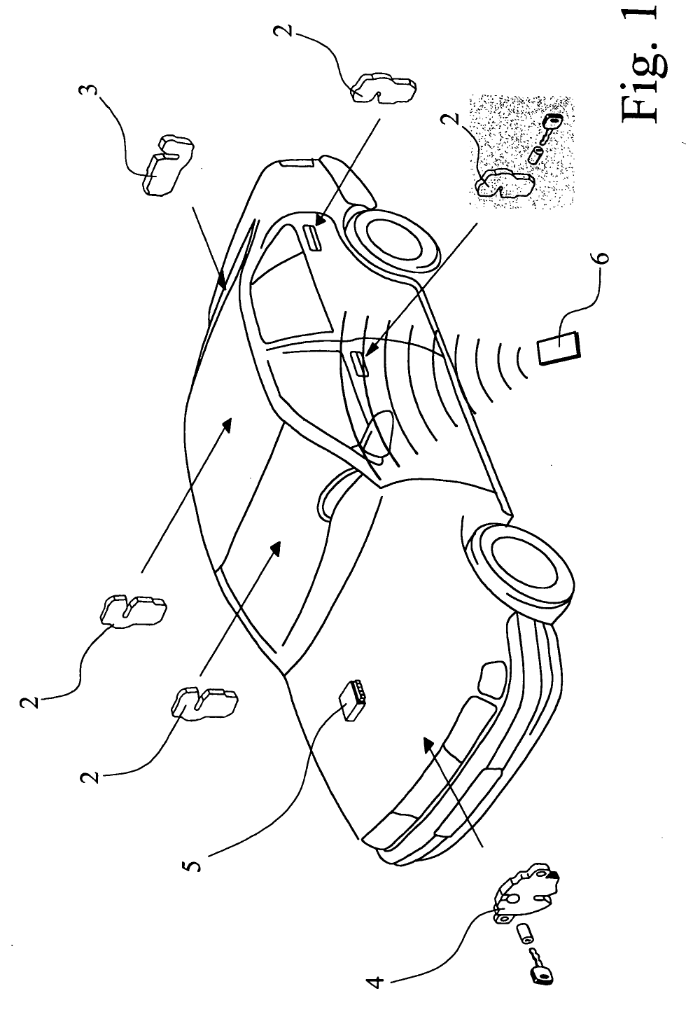

In the drawings, FIG. 1 shows a motor vehicle 1 with a motor vehicle door locking system in accordance with the invention. The motor vehicle door locking system can include several motor vehicle locks 2, 3, especially for motor vehicle doors, one motor vehicle rear hatch or the like, and a hood lock 4, the installation positions of which are shown schematically in FIG. 1. The motor vehicle locks 2, 3 can be locked and unlocked by a motor in the sense of central locking. In one version as an electric lock, each motor vehicle lock 2, 3 additionally has the possibility of motorized opening. Therefore, lifting of a ratchet (not shown) occurs by means of an opening drive (also not shown).

To implement the system and functions of the motor vehicle door locking system of the present invention, a control 5 which, as shown in FIG. 1, can be centralized as a primary control 5. But it can also be provided that the control 5 is decentralized, therefore distributed in the individual motor vehicle locks 2, 3.

In order to be able to remotely trigger the system functions of the motor vehicle door locking system, there is an operator-side mobile part 6. Depending on the operating concept of the motor vehicle door locking system, the mobile part 6 can be made as a wireless remote control. The mobile part 6, however, can also be made as a data medium which does not make available an actuating possibility for the operator. Such a mobile part is conventional in motor vehicle door locking systems with passive entry function, as has already been shown. Triggerability of system functions by the mobile part 6 in the present application means that when the mobile part 6 is made as a wireless remote control, by manual actuation of the wireless remote control, a system function can be triggered and that when the mobile part 6 is made as a data medium, a system function can be triggered by the approach of the operator and of the data medium to the motor vehicle 1.

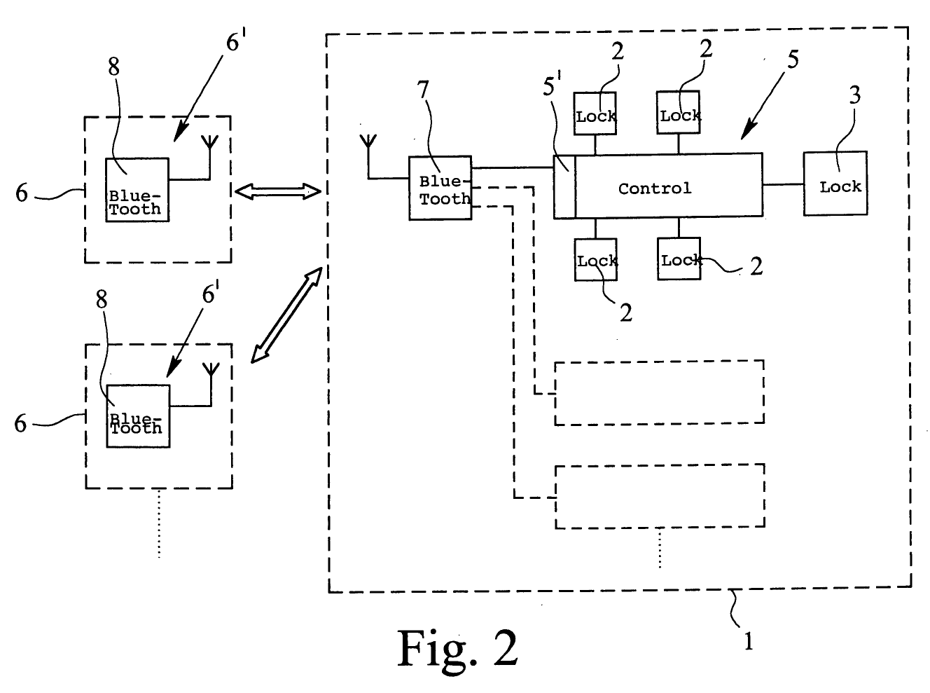

In both of the above-described operating concepts, the control 5 and the mobile part 6 each have communications electronics 5′, 6′ via which a bidirectional wireless link between the control 5 on the one hand and the mobile part 6 on the other can be set up (see FIG. 2 as described in more detail below). The communications electronics 5′, 6′ is coupled to another component 7 in order to be able to set up the wireless link. Over the wireless link, at least one system function of the motor vehicle door locking system can be triggered by the mobile part 6.

It is important that the wireless link between the control 5 and the mobile part 6 is a wireless link according to the Bluetooth industry standard. This wireless link is called a Bluetooth wireless link below. The advantages associated with the Bluetooth wireless link have already been explained in the Summary of the Invention section.

In one configuration, the communication electronics 5′ of the control 5 and the communication electronics 6′ of the mobile part 6, each have one Bluetooth interface 7, 8.

In various modern motor vehicles, on the vehicle-side there is already a Bluetooth interface 7, for example, to trigger a headset or to receive sensor signals of a parking guidance system or a tire pressure measurement system. In one embodiment of the invention, the communications electronics of the control 5 is coupled to the Bluetooth interface 7 which is already present in the motor vehicle 1. This leads to an especially compact structure. FIG. 2 shows one such structure. The Bluetooth interface 7 is coupled to other control components of the motor vehicle 1, shown by the broken line.

The hardware of the Bluetooth interface 7, 8 is currently available as a mass-produced article, as discussed above. In addition to the low cost, it is especially advantageous that the dimensions of the hardware of a Bluetooth interface 7, 8 are comparatively small. The small dimensions of the hardware of the Bluetooth interface make it possible to integrate this hardware into small articles as well. For example the mobile part 6 can be made here as a card, a key ring or as a component of the key. There are numerous other possibilities to which reference should be made.

It has already been pointed out in the Summary of the Invention that the spread of the Bluetooth industry standard, especially for mobile electronic devices such as mobile phones and PDAs, has already progressed far. Against this background, the mobile part 6, in one preferred configuration, is a mobile electronic device, preferably a mobile phone or a PDA with an integrated Bluetooth interface. For example, it is then possible, with an electronic organizer which the operator is carrying anyway, to trigger certain system functions of the motor vehicle door locking system, as is explained below. For this purpose, it is simply necessary to input the Bluetooth device address of the electronic organizer one time into the motor vehicle-side Bluetooth interface 7 and to input a secret code word in the two devices or store them there. Then, upon entry of the password, the Bluetooth communication control automatically undertakes control.

The aforementioned configuration of the motor vehicle-side Bluetooth interface acquires special importance when several different mobile parts 6 are to be used. FIG. 2 shows here there are a series of mobile parts 6 which all communicate with the control 5 over the Bluetooth wireless link. Here, a simple usage interface can be made available to the user on the motor vehicle 1 or on the mobile part 6 in order to be able to easily “log on” new Bluetooth devices (mobile phones, PDAs, etc) as described above, in the control 5.

One major advantage when using an electronic device such as a cellular telephone or PDA as the mobile part 6 is that these devices are generally equipped with an efficient power supply. The above described problem of equipping the mobile part 6 with a corresponding power supply is thus made relative.

Various system functions of the motor vehicle locking system which can be triggered by the mobile part 6 over the Bluetooth wireless link. In one exemplary configuration, these system functions include unlocking of the motor vehicle lock 2, 3 in the manner of a central locking system. In another preferred configuration, it can also be provided that the system function which can be triggered by the mobile part 6 is motorized opening of the motor vehicle lock 2, 3. This is especially useful and advantageous for the motor vehicle lock 3 of a rear hatch (shown in FIG. 1).

The aforementioned configuration of the wireless link between the control 5 and the mobile part 6 provide advantages when the motor vehicle door locking system has a passive entry function. As was already explained in the Summary of the Invention, the approach of the operator with the mobile part 6 to the motor vehicle 1 leads to the control 5, after a starting interval and an authentication check interval, triggering an action interval for unlocking the motor vehicle lock 2, 3. In doing so, all motor vehicle locks 2, 3 of the motor vehicle 1 or, for example, only the motor vehicle lock 2 of the driver's door can be unlocked.

The Bluetooth services offered by the Bluetooth industry standard can be advantageously used to implement the passive entry function. They include, as described above, that a Bluetooth interface 7, 8 can be shifted into a so-called “sniff mode” or into a comparable mode and cyclically awaits a so-called “inquiry message” of the other Bluetooth interface 7, 8. Preferably, the Bluetooth interface 7 of the control 5 or the Bluetooth interface 7 coupled to the communication electronics 5′ of the control 5 is switched into the “sniff mode” and waits for an “inquiry message” of the Bluetooth interface 8 of the mobile part 6. Depending on the application, the reverse constellation can also be reasonable. In any case, one of the two Bluetooth interfaces 7, 8 must be switched into the “sniff mode” and the other Bluetooth interface must continuously send “inquiry messages”. Here, essentially the generally limited power supply of the mobile part 6 will have to be considered.

In the two aforementioned cases, the Bluetooth interface 7 of the control 5 and the Bluetooth interface 8 of the mobile part 6 automatically “discover” one another and start a Bluetooth connection setup procedure. This process corresponds to the above explained starting interval as is provided with regard to the passive entry function.

The automatic Bluetooth connection setup is followed by the Bluetooth authentication interrogation, which proceeds in a manner which is likewise fixed according to Bluetooth industry standard. In one especially preferred configuration, this Bluetooth authentication interrogation is used as the authentication check interval for the passive entry function.

As a result, both the starting interval and the authentication check interval are completely taken over by the communications mechanism which is fixed in the Bluetooth industry standard. A proximity sensor for triggering is no longer necessary.

There is a series of other Bluetooth services which are established in the Bluetooth industry standard and which can be advantageously used for a motor vehicle door locking system of the present invention. A Bluetooth service includes, for example, measuring the reception level at a Bluetooth interface via the RSSI (Receiver Strength Signal Indicator). Furthermore, it is possible for it to be negotiated with the Bluetooth interface whether the reception level is to be raised or lowered.

With the above-described Bluetooth service of “negotiating” the transmission power, it is possible for the two Bluetooth interfaces 7, 8 to control their respective transmission power such that the transmission power, depending on the length of the Bluetooth wireless link, is just enough to maintain the Bluetooth wireless link. This is advantageous in that eavesdropping on the communication between the two Bluetooth interfaces 7, 8 is made much more difficult. It is now necessary specifically for unauthorized eavesdropping to approach one of the two Bluetooth interfaces 7,8 to in any case less than 10 m (whisper mode).

According to another preferred configuration, the above-described Bluetooth service of measuring the respective reception level can be used to block the triggering of certain system functions when the mobile part 6, the operator, is too far away from the motor vehicle 1. In the case of implementing the motor vehicle door locking system with a passive entry function, depending on the application it can be advantageous if the unlocking of the motor vehicle lock 2, 3 takes place immediately when the distance between the mobile part 6 and the motor vehicle 1 falls below the 10 m limit. Especially in an urban environment unlocking can be undesirable from this comparatively great distance.

Therefore, it is provided, in one exemplary configuration, that from the measured reception level, the distance of the mobile part 6 from the motor vehicle 1 is determined and that the control 5 then enables or blocks the triggering of a system function depending on the determined distance. One example of this is the enabling of automatic unlocking of the motor vehicle lock 2, 3 only when the mobile part 6, therefore the operator, is at a distance of less than 3 m from the motor vehicle. In this case, automatic Bluetooth connection setup and Bluetooth authentication interrogation take place when the operator enters the 10 m limit. The action interval in which the unlocking of the motor vehicle lock 2, 3 takes place is blocked by the control 5 until the determined distance reaches the 3 m limit.

The described distance-dependent enabling can be provided for all system functions of the motor vehicle door locking system. There can even be interior detection so that starting the engine by pressing a button is only possible when the operator is in the motor vehicle with the mobile part 6 (e.g., passive-go).

According to another exemplary embodiment of the invention which acquires independent importance, the use of a wireless link according to the Bluetooth industry standard is claimed for the wireless link of the described motor vehicle door locking system. In this connection, it should be pointed out that the expression “use of a wireless link” means not only the use of the components necessary for building up this wireless link, but also the software operated in these components according to the Bluetooth industry standard.

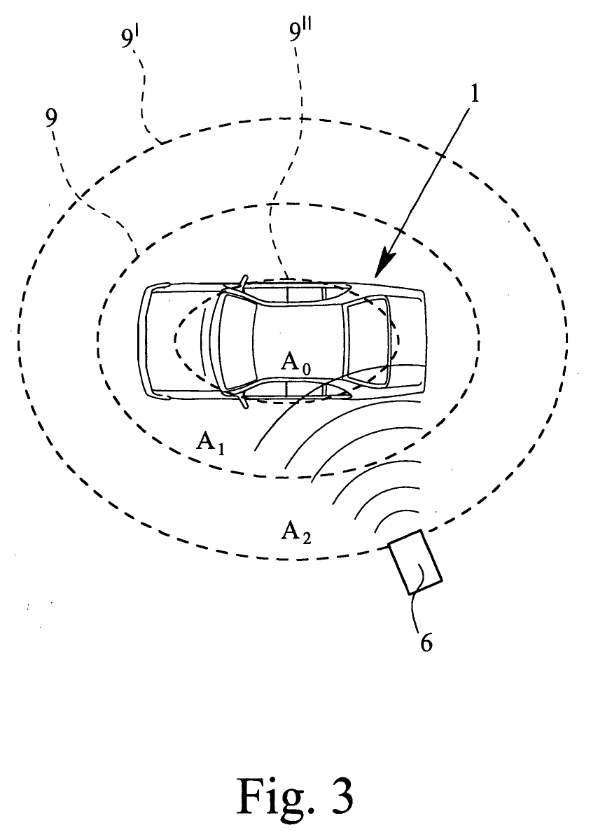

In the embodiment shown in FIG. 3, a predetermined distance range around the vehicle 1 is assigned to the system function of unlocking of a motor vehicle lock 2, 3 or several motor vehicle locks 2, 3. This distance range is defined in FIG. 3 by the broken line 9 and is labeled A₁. The control 5 then enables the triggering of the aforementioned unlocking by the mobile part 6 when the mobile part 6 is located within the distance range A₁ assigned to this system function.

It is important, at this point, that in addition to the system function “unlocking,” there is at least one other system function which can be one of the luxury functions or the like discussed in the Summary of the Invention. At least two distance ranges A₁, A₂ are dictated by the control 5, the system functions being assigned to the different distance ranges A₁, A₂. Here the distance range A₁, shown in FIG. 3, is defined by the broken line 9′. The different distance ranges are stored in the control 5. Furthermore, in the control 5 logic operations are stored which image the assignment of a system function to a distance range A₁, A₂ or several distance ranges A₁, A₂ in terms of control engineering.

Various possibilities are conceivable for defining a distance range A₁, A₂ by parameters and to store the parameters as described above in the control 5. For example, a distance range A₁, A₂ can be circular so that the parameter which is to be stored is the radius of the circle. In this preferred embodiment the distance range A₁, A₂ is made elliptical so that the parameters to be stored here are the two semiaxes of the ellipse. As follows from FIG. 3, the elliptical shape is especially advantageous due to the generally elongated configuration of the vehicle 1. Also, parts or angle ranges of a circle or an ellipse are defined as the distance range. This can be a good idea, for example, when a certain system function relates to a certain area of the vehicle. One example is the system function of motorized opening of the rear hatch which could be assigned to the rear area of the vehicle. Finally, ring-shaped distance ranges are also possible in certain applications.

Based on the aforementioned assignment of system functions to different distance ranges A₁, A₂, the control 5 enables triggering of the system function only when the mobile part 6 is located within the distance range from A₁ to A₂ which is assigned to the affected system function. When the mobile part 6 is made as a radio remote control, as already explained, this has the advantageous effect that unwanted triggering of certain system function from a great distance is avoided.

For passive entry systems, the above described concept in addition to the automatic triggering of unlocking also enables automatic triggering of luxury functions or the like without always having to unlock the motor vehicle lock 2, 3 or several motor vehicle locks 2, 3. One possible configuration of such a passive entry system is explained below.

There are a series of possibilities for determination by the control 5 regarding in which distance range A₁, A₂ the mobile part 6 is located. One preferred possibility is that the vehicle-side or individual-side reception level of the wireless link can preferably be measured by the control 5. The control 5 can next determine from the measured reception level, the distance of the mobile part 6 from the vehicle 1. The corresponding distance range A₁, A₂ can then be determined from the distance which has been determined in this way.

The Bluetooth industry standard makes available a Bluetooth service with which the reception level at the Bluetooth interface can be measured via the RSSI (Receiver Strength Signal Indicator) value. Here, in one exemplary version, the respective transmitter power can be kept at a certain value which forms the reference for evaluation of the measured RSSI value. Also, the transmitting part sends the value of the current transmitted power to the receiver which then forms the aforementioned reference.

The approach is not limited to certain system functions. Preferably, a system function which can be triggered by the mobile part 6, in addition to the explained unlocking, is a function such as activation of the front end lights, the blinker or the interior lighting or such as operator-specific adjustment of the vehicle seat or the vehicle mirror.

In one configuration, the vehicle I has motor vehicle lock 2, 3 which can be unlocked by motor and that one of the system functions which can be triggered by the mobile part 6 is motorized unlocking of the motor vehicle lock 2, 3

Especially for vehicle rear latches is it provided that the motor vehicle has a vehicle lock 3 which can be opened by a motor and that one of the system functions which can be triggered by the mobile part 6 is motorized opening of the motor vehicle lock 3.

Another system function to which generally an especially spacious distance range around the vehicle 1 will be assigned, is activation of an authentication check interval. Since this authentication check interval can require a certain time depending on the configuration, it can be advantageous if, as the operator with the mobile part approaches from a long distance, the authentication check interval is activated without necessarily any other function, such as, for example, a luxury function, being activated. Thus, the possibly lengthy communication which is necessary for the authentication check interval is already completed when a system function such as, for example, unlocking of the motor vehicle lock 2, 3 is to be undertaken.

The approach set forth in the present invention provides special advantages when a system function, which is enabled by the control 5, can be triggered by manual actuation of the mobile part 6, when the mobile part 6 is made as a wireless remote control. This has already been explained above.

The solution for the configuration of the motor vehicle door locking system with a function in the manner of a passive entry system has special advantages. The movement of the mobile part 6 into the distance range which is assigned to the system function, preferably unlocking of the motor vehicle lock 2, 3, automatically causes triggering of the pertinent system function. When the operator with the mobile part 6 approaches, an exemplary embodiment, distance of roughly 20 m the blinker and the front end lights are activated; at a distance of roughly 10 m the interior illumination is activated and the operator-specific adjustment of the vehicle seat and the vehicle mirror is undertaken; and that at a distance of roughly 2 m the unlocking of the driver-side motor vehicle lock 2 or all motor vehicle locks 2, 3 is carried out. Of course, depending on the application, other distance ranges are also conceivable here.

In certain situations it can also be advantageous that not all the aforementioned system functions, but only some of then, are triggered automatically, (i.e., without manual activation on the mobile part 6). According to an exemplary embodiment, the mobile part 6 on one hand is made as a data medium in the sense of the passive entry system and on the other hand as a wireless remote control. This leads to maximum ease of operation with simultaneously maximum flexibility.

A further enhancement of user friendliness can be achieved by enabling the starting of the engine of the motor vehicle 1, via an actuation arrangement in the interior of the vehicle 1, preferably via a pushbutton or the like, and by the control 5 enabling the starting of the engine when the mobile part 6 is in the interior of the vehicle 1. Thus, an ignition key or the like is not needed to start the vehicle 1 since via determining the distance of the mobile part 6 and thus of the operator it can be recognized that the mobile part 6 and thus the operator are in the distance range A₀ which is defined by the broken line 9″ in FIG. 3, i.e. in the interior of the vehicle 1. An authentication check interval has then already preferably been carried out, as explained above, from a great distance.

What is claimed is:

1. Motor vehicle door locking system comprising:
at least one motor vehicle lock, wherein the motor vehicle lock is at least one of locked, unlocked and opened by a motor;
a motor vehicle-side control; and
an operator-side mobile part, each of the control and the mobile part including communications electronics, wherein the communications electronics create a bidirectional wireless link between the control and the mobile part, wherein at least one system function of the motor vehicle door locking system is triggerable by the mobile part via the wireless link, and wherein the wireless link is a Bluetooth wireless link.

2. Motor vehicle door locking system as claimed in claim 1, wherein the communications electronics of the control either includes a Bluetooth interface or is coupled to a Bluetooth interface located in the vehicle, and wherein the communications electronics of the mobile part has a Bluetooth interface.

3. Motor vehicle door locking system as claimed in claim 1, wherein the mobile part is a card, a key ring or a component of a key.

4. Motor vehicle door locking system as claimed in claim 1, wherein the mobile part is a mobile phone with an integrated Bluetooth interface or a personal digital assistant (PDA) with an integrated Bluetooth interface.

5. Motor vehicle door locking system as claimed in claim 1, wherein the system function is unlocking of the motor vehicle lock.

6. Motor vehicle door locking system as claimed in claim 1, wherein the system function is motorized opening of the motor vehicle lock.

7. Motor vehicle door locking system as claimed in claim 5, wherein the motor vehicle door locking system includes a passive entry function in which, as the operator with the mobile part approaches the motor vehicle, the control, after a starting interval and an authentication check interval, triggers an action interval for unlocking the motor vehicle lock.

8. Motor vehicle door locking system as claimed in claim 7, wherein the starting interval corresponds to an automatic Bluetooth connection setup between the Bluetooth interface of the control and the Bluetooth interface of the mobile part that occurs when the mobile part approaches the motor vehicle.

9. Motor vehicle door locking system as claimed in claim 8, wherein the authentication check interval corresponds to a Bluetooth authentication interrogation which follows the Bluetooth connection setup.

10. Motor vehicle door locking system as claimed in claim 2, wherein depending on the length of the Bluetooth wireless link, the two Bluetooth interfaces control their respective transmission power via a Bluetooth service such that the transmission power maintains the Bluetooth wireless link without the use of extraneous transmission power.

11. Motor vehicle door locking system as claimed in claim 2, wherein the vehicle-side or operator-side reception level of the Bluetooth wireless link can be measured by the control, wherein from the measured reception level, the distance of the mobile part from the motor vehicle is determined by the control and wherein the control enables or blocks the triggering of the at least one system function depending on the determined distance.

12. Motor vehicle door locking system as claimed in claim 11, wherein the control enables triggering of the system function only when the mobile part is located within a predetermined distance range (A₁) around the vehicle.

13. Motor vehicle door locking system as claimed in claim 12, wherein the control enables system functions, triggered by the mobile part, where two distance ranges (A₁, A₂) are used, wherein the system functions are assigned to different distance ranges (A₁, A₂) and wherein the control enables triggering of a system function when the mobile part is located within the distance range A₁ to A₂.

14. Motor vehicle door locking system as claimed in claim 2, wherein the at least one system function triggered by the mobile part further comprises at least one of activation of the front end lights, the blinker or the interior lighting of the motor vehicle or such as operator-specific adjustment of the seat or the mirror of the motor vehicle.

15. Motor vehicle door locking system as claimed in claim 13, wherein the at least one system function triggered by the mobile part further comprises at least one of activation of the front end lights, the blinker or the interior lighting of the motor vehicle or such as operator-specific adjustment of the seat or the mirror of the motor vehicle.

16. Motor vehicle door locking system as claimed in claim 2, wherein the vehicle has motor vehicle lock which can be unlocked by motor and wherein one of the system functions which can be triggered by the mobile part is motorized unlocking of the motor vehicle lock.

17. Motor vehicle door locking system as claimed in claim 13, wherein one of the system functions is motorized unlocking of the motor vehicle lock.

18. Motor vehicle door locking system as claimed in claim 15, wherein one of the system functions is motorized unlocking of the motor vehicle lock

19. Motor vehicle door locking system as claimed in claim 2, wherein one of the system functions is motorized opening of the motor vehicle lock.

20. Motor vehicle door locking system as claimed in claim 13, wherein one of the system functions is motorized opening of the motor vehicle lock.

21. Motor vehicle door locking system as claimed in claim 17, wherein one of the system functions is motorized opening of the motor vehicle lock.

22. Motor vehicle door locking system as claimed in claim 2, wherein one of the system functions is the activation of an authentication check interval.

23. Motor vehicle door locking system as claimed in claim 13, wherein one of the system functions which is the activation of an authentication check interval.

24. Motor vehicle door locking system as claimed in claim 17, wherein one of the system functions is the activation of an authentication check interval.

25. Motor vehicle door locking system as claimed in claim 2, wherein at least one system function which is enabled by the control can be triggered by manual actuation of the mobile part.

26. Motor vehicle door locking system as claimed in claim 21, wherein at least one system function which is enabled by the control can be triggered by manual actuation of the mobile part.

27. Motor vehicle door locking system as claimed in claim 13, wherein the movement of the mobile part into the distance range (A₁, A₂) automatically causes triggering of the pertinent system function.

28. Motor vehicle door locking system as claimed in claim 1, wherein the engine of the motor vehicle is started via an actuation arrangement in an interior (A₀) of the vehicle, and wherein the control enables the starting of the engine when the mobile part is in the interior (A₀) of the vehicle.

29. Motor vehicle door locking system as claimed in claim 13, wherein the engine of the motor vehicle is started via an actuation arrangement in an interior (A₀) of the vehicle, and wherein the control enables the starting of the engine when the mobile part is in the interior (A₀) of the vehicle.

30. Motor vehicle door locking system as claimed in claim 17, wherein the engine of the motor vehicle is started via an actuation arrangement in an interior (A₀) of the vehicle, and wherein the control enables the starting of the engine when the mobile part is in the interior (A₀) of the vehicle.

31. Motor vehicle door locking system as claimed in claim 18, wherein the engine of the motor vehicle is started via an actuation arrangement in an interior (A₀) of the vehicle, preferably via a pushbutton or the like, and wherein the control enables the starting of the engine when the mobile part is in the interior (A₀) of the vehicle.
